(19) United States
(12) Patent Application Publication
(10) Pub. No.: US 2016/0169068 A1
(43) Pub. Date: Jun. 16, 2016

(54) TURBINE BEARING LUBRICANT FILTRATION SYSTEM

(71) Applicant: DONALDSON COMPANY, INC., Minneapolis, MN (US)

(72) Inventor: Philip Edward Johnson, Apple Valley, MN (US)

(73) Assignee: DONALDSON COMPANY, INC., Minneapolis, MN (US)

(21) Appl. No.: 14/908,970

(22) PCT Filed: Jul. 29, 2014
(86) PCT No.: PCT/US2014/048700

§ 371 Date: Jan. 29, 2016

Related U.S. Application Data
(60) Provisional application No. 61/859,416, filed on Jul. 29, 2013.

(51) Int. Cl. F01M 1/10; B01D 53/04; F01M 1/02

(52) U.S. Cl. CPC F01M 1/10; F01M 1/02; B01D 53/04; F01M 2001/1028

(57) ABSTRACT

The technology disclosed herein generally relates to a turbine bearing lubricant filtration system. A lubricant pump is configured to be disposed in communication with a lubricant reservoir. A dry gas source is configured to be in fluid communication with the lubricant reservoir. A breather filter is configured to be in communication with the lubricant reservoir, and a filter manifold assembly having media incorporating electrostatic reduction technology. Other embodiments are also described.

This application is being filed as a PCT International Patent application on Jul. 29, 2014 in the name of Donaldson Company, Inc., a U.S. national corporation, applicant for the designation of all countries and Philip Edward Johnson, a Citizen of the United Kingdom, inventor for all designated states, and claims priority to U.S. Patent Application No. 61/859,416 filed Jul. 29, 2013 the contents of which is herein incorporated by reference in its entirety.

### BACKGROUND

Bearing lubricant filtration systems associated with turbines typically have a lubricant reservoir holding a lubricant. A pump pumps the lubricant through a filter or series of filters and then to the turbine bearings. The filter and lubricant are typically non-conductive materials and, as such, fluid flow in the system can generate electrostatic charge. The electrostatic charge can result in discharge, or sparking, within the components of the system. The electrostatic charging can reduce the life of system components including the bearings, filters, and reservoirs through the buildup of varnish and physical damage to the filter. To alleviate risks associated with sparking, some lubricant filtration systems are designed to eject potentially-flammable fumes from the lubricant reservoir. Such an approach can create resultant airflow back into the lubricant reservoir, where such air carries with it dust (or other debris) and moisture, which each cause contamination, and oxygen, which can contribute to the oxidation of system components when combined with the sparks associated with electrostatic discharge. The technology disclosed herein generally related to a lubricant filtration system, and more particularly to a turbine bearing lubricant filtration system.

### SUMMARY OF THE INVENTION

The technology disclosed herein generally related to a lubricant filtration system, and more particularly to a turbine bearing lubricant filtration system.

### BRIEF DESCRIPTION OF THE DRAWINGS

The invention may be more completely understood and appreciated in consideration of the following detailed description of various embodiments of the invention in connection with the accompanying drawings.

FIG. 1 is a schematic of an example turbine bearing lubricant filtration system, consistent with the technology disclosed herein.

FIG. 2 depicts an example breather filter consistent with the technology disclosed herein.

FIG. 3 depicts a second example breather filter consistent with the technology disclosed herein.

FIG. 4 depicts an example filter manifold assembly consistent with the technology disclosed herein.

FIG. 5 depicts the flow path associated with the example filter manifold assembly of FIG. 4.

FIG. 6 depicts graphical results for airspace relative humidity in an experimental air drying system consistent with the technology disclosed herein.

FIG. 7 depicts graphical results for percent saturation of oil in the experimental air drying system of FIG. 6.

### DETAILED DESCRIPTION

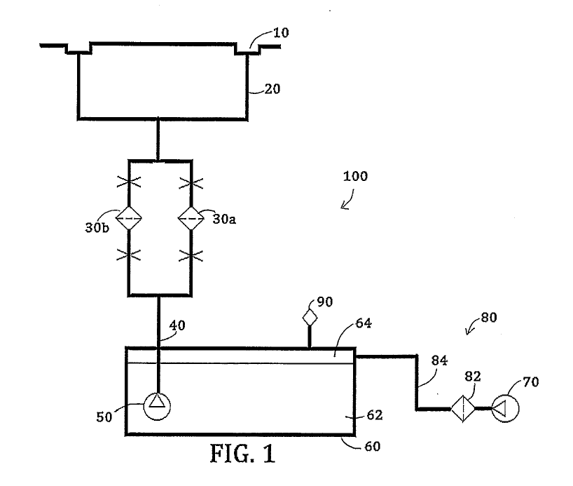

The technology disclosed herein generally related to a lubricant filtration system, and more particularly to a turbine bearing lubricant filtration system. FIG. 1 depicts an example schematic of such a system 100. Lubricant 62 is generally stored in a lubricant reservoir 60 and is pumped via pump 50 through a pump line 40 through lubricant filters 30a, 30b and into turbine bearings 10 via turbine lines 20.

The lubricant reservoir 60 is generally configured to hold the lubricant 62 and defines an airspace 64 between the lubricant 62 and a portion of the inside surface of the lubricant reservoir 60. The lubricant reservoir 60 can be constructed of a variety of materials known in the art.

In a variety of implementations, fumes and moisture can be released from the lubricant 62 into the air within the airspace 64, where “moisture” is defined as water or water vapor, and “air” is defined generally as gaseous substances and airborne matter contained therein. The fumes can create significant risk in the presence of static electric discharge, and the moisture can contribute to oxidation of system components, particularly in the presence of static discharge. As such, a breather filter 90 is disposed in fluid communication with the airspace 64 defined in the reservoir 60, where the breather filter 90 is generally configured to vent the air from the lubricant reservoir 60. In some embodiments the breather filter 90 can also be configured to filter out particulates between the airspace 64 and the atmosphere outside of the lubricant reservoir 60. In a variety of embodiments the breather filter 90 is a regenerative hygroscopic breather filter. In at least one embodiment the breather filer 90 is a T.R.A.P. Breather Filter manufactured by Donaldson Corporation headquartered in Bloomington, Minn. Those having skill in the art will appreciate that other breather filters may also be appropriate for specific implementations of the technology disclosed herein.

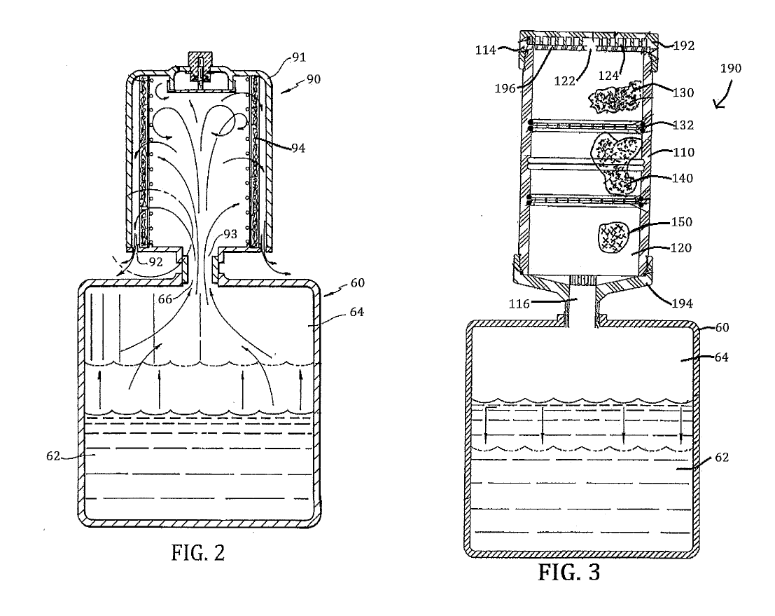

FIG. 2 depicts a schematic of an example regenerative hygroscopic breather filter 90 mounted to a lubricant reservoir 60 consistent with the technology disclosed herein. The breather filter 90 may be mounted to the lubricant reservoir 60 by any suitable and well known means, such as a standard pipe fitting. The breather filter 90 generally has a housing 91 containing an inlet port 92 and an outlet port 93, where the outlet port 93 is in fluid communication with the airspace 64 defined in the lubricant reservoir 60 through a tank breather filter opening 66. A hydrophilic filter element 94 is positioned within the housing 91 between the inlet port 92 and outlet port 93 and is configured to filter solid particulate matter and moisture when air passes into the inlet port 92 and through the filter element 94. The filter element 94 is also configured to release moisture via the inlet port 92 when air passes from the outlet port 93 through the filter element 94.

The filter element 94 generally has an inherently air permeable substrate treated with a hydrophilic substance, where the substrate is substantially impervious to particulate matter such as dust. In a variety of embodiments, the substrate is selected from the group consisting of foamed polyurethane, polyester felt, polyethylene fibers and cellulosic paper. The hydrophilic substance is selected from the group consisting of lithium chloride, calcium chloride, polyacrylic acid, polyvinylpyrrolidone, polyvinyl alcohol, glycol, and glycerine. In a variety of embodiments, the breather filter can be consistent with the disclosure of U.S. Pat. No. 5,575,832, which is incorporated by reference herein.

As the system 100 depicted in FIG. 1 is in operation, the fluid level in the reservoir 60 fluctuates, which varies the volume of the airspace 64 which, in turn, varies the pressure within the reservoir 60. As such, as the fluid level falls, the airspace 64 expands and a relative vacuum is created which draws ambient air from the atmosphere through the inlet port 92, through the filter element 94 and then through the outlet port 93 into the reservoir 60. When the fluid level rises, the airspace 64 contracts, and the relatively pressurized air is forced out of the reservoir 60 through outlet 93, through the filter element 94 and escaping to the atmosphere through the inlet 92. Due to frictional forces during system operation, the temperature inside of the reservoir 60, including the airspace 64, is slightly higher than the temperature of ambient air, which facilitates the ability of the filter element 94 to release moisture captured therein. In some embodiments, the breather filter 90 can also expel particulate matter captured therein.

In some embodiments, which will be described in more detail, below, the airspace in the reservoir can be put under positive pressure. In such embodiments a breather filters as described herein can still be incorporated in the design, although air would primarily, if not exclusively, pass from the interior volume of the reservoir to the atmosphere.

In a variety of embodiments, the breather filter can be a hygroscopic breather filter consistent with the disclosure of International App. Ser. No. PCT/US13/29138, filed Mar. 5, 2013, which is incorporated by reference herein, which operates similarly as the breather filter described above. FIG. 3 depicts a schematic of a second example regenerative hygroscopic breather filter 190 consistent with said application. In reference first to FIGS. 1 and 2, the breather filter 190 has a housing 110 defining an interior volume 112, a first port 114, and a second port 116. The first port 114 is generally in communication with the atmosphere, and the second port 116 is generally in communication with the lubricant reservoir 60 and, in particular, the airspace 64 defined within the lubricant reservoir 60. In the current embodiment the breather filter 190 has a first end cap 192 and a second end cap 194, although other configurations are also contemplated.

The breather filter 190 of the current embodiment defines a diffusion channel 124 that has a labyrinth arrangement communicatively coupling the first port 114 with the volume 120 defined by the breather filter housing through a diffusion aperture 122. By the term “labyrinth arrangement,” it is meant a deliberately meandering airflow path that is non-linear (as a whole) and is maze-like. In the current embodiment the diffusion channel 124 is defined by the end cap 192 and an adjacent plate 196, however in some embodiments the diffusion channel 124 is defined entirely within the end cap 192. The labyrinth arrangement of the diffusion channel 124 can have a variety of configurations, as will be appreciated by those having skill in the art. In at least one embodiment, the labyrinth arrangement of the diffusion channel 124 will have an L/D ratio of at least 50, in which L is a length of the diffusion channel 124 and D is an equivalent channel diameter and is calculated by the following equation:

$$D = \sqrt{\frac{4}{π} \times A} ,$$

where A=channel width×channel height. It some embodiments, the L/D ratio is preferably no greater than 380. In one embodiment the L/D ration is about 150, assuming a maximum flow of 100 l/min (3.5 f³/min) and a max pressure drop of 0.5 psid. The L/D ratio in these ranges will allow for the life of the adsorbent material to be increased sufficiently without an excessive increase in the restriction of airflow between the airspace 64 and the atmosphere.

The volume 120 defined by the breather filter 190 generally contains adsorbent materials such as a first adsorbent material 130 and a second adsorbent material 140. In this particular embodiment a scrim 132 separates the first adsorbent material 130 from the second adsorbent material 140, and an expansion foam 150 is disposed between the second port 116 and the second adsorbent material 140. It should be noted that the first adsorbent material 130 and second adsorbent material 140 are shown schematically, with only a portion being illustrated. In actual implementation those having skill in the art will understand that such materials would occupy the entire volume of their respective spaces within the interior volume 120 of the housing 110. The first adsorbent material 130 is in fluid communication with the diffusion aperture 122 and the second adsorbent material 140 is in fluid communication with the second port 116 such that air passing through the breather filter 190 from the reservoir airspace 64 will pass through the expansion foam 150, the second adsorbent material 140, the first adsorbent material 130, the diffusion aperture 122, the diffusion channel 124, and finally out the first port 114 to the atmosphere. Similarly, air passing through the breather filter 190 from the atmosphere to the reservoir 60 would travel the same pathway in the opposite direction.

In multiple embodiments, the first adsorbent material 130, which is adjacent the first port 114 has a higher capacity of adsorption at a high relative humidity than the second adsorbent material 140, which will adsorb a greater amount of moisture at a lower relative humidity than the first adsorbent material 130. In one embodiment, the first adsorbent material 130 comprises activated carbon or a blend thereof. The second adsorbent material 140 can comprise a silica gel material and is a material that changes in color in response to a predetermined level of adsorption. When the second adsorbent material 140 changes color, this can provide a visual indication to a user that the breather filter 190 needs to be serviced or replaced. The housing 110, in this example, can be partially or entirely transparent. For example, the housing 110 may comprise transparent PVC or polycarbonate. In one example embodiment, the second adsorbent material 140 comprises silica gel or a blend thereof. Instead of silica gel or mixed with silica gel there can include calcium sulfate and/or zeolites.

Referring back to FIG. 1, an air drying system 80 having a dry gas/nitrogen source 82 is also in fluid communication with the airspace 64 in a variety of embodiments via a dry gas line 84 and a dry gas pump 70. The term “dry gas” is generally intended to mean gas that is capable of absorbing moisture from the airspace 64 of the reservoir 60 and the lubricant 62 within the reservoir 60. Generally, as the moisture content from a gas is removed, the ability of the gas to absorb moisture is increased. As such, when the dry gas is introduced to the airspace, the gas can absorb moisture from the airspace 64 and the lubricant 62.

In some embodiments, the dry gas is atmospheric air that is compressed to condense and remove the moisture. Atmospheric air can also be dried through the use of refrigeration dryers, pressure swing adsorption dryers, membrane dryers and/or a combination of coolers and blowers. In some applications a combination of air compression and filters may be used. Further, dry gas from other sources or processes within the system may be used instead of dry atmospheric air.

In the current embodiment, the dry gas source 82 for the air drying system 80 is a nitrogen generator such as a swing type compressor used in combination with one or more molecular sieves. In a variety of embodiments the nitrogen generator uses Pressure Swing Adsorption Technology, as will be appreciated by those having skill in the art. In at least one embodiment, 1-3 ft³/min of nitrogen is produced by the dry gas source 82 and pumped through the dry gas pump 70 into the lubricant reservoir 60. Other inert gasses can also be used. In a variety of embodiments the dry gas will have substantially minimal moisture content such that it can contribute to releasing moisture from the lubricant 62 and the breather filter 90.

The dry gas is generally pumped through the dry gas line 84 into the lubricant reservoir 60, which displaces the air within the airspace 64 to be vented to the atmosphere through the breather filter 90. In at least one embodiment the dry gas is pumped through the dry gas line 84 into the lubricant 62 and is released by the lubricant 62 into the airspace 64, while in another embodiment the dry gas is pumped through the dry gas line 84 into the airspace 64 defined by the lubricant reservoir 60.

In many lubricant systems, oxygen can also be present in the airspace 64 defined between the lubricant reservoir 60 and the lubricant 62. The presence of oxygen also contributes to oxidation of system components, particularly in combination with static electricity discharge. As such, pumping a dry inert gas such as dry nitrogen into the airspace substantially eliminates the system risks associated with oxygen, moisture, and fumes when combined with static electric discharge. Additionally, in at least one embodiment, the gas in the lubricant reservoir 60 can be slightly pressurized to prevent ingress of atmospheric air, which contains non-inert components such as moisture, oxygen, and dust.

System factors that can affect the effectiveness of air drying system 80 include the temperature of the lubricant 62 and the flow rate of dried gas introduced into the airspace 64 of the reservoir 60. As the temperature of the lubricant 62 is increased, the gas drying system 80 can become more effective because the heated lubricant 62 can have a higher saturation point than lubricant at a lower temperature and will therefore have a lower percent saturation for a fixed amount of dissolved water. In a variety of embodiments, the temperature of the lubricant 62 increases during system 100 use. In some embodiments, however, the system 100 can incorporate a heating mechanism to heat the lubricant 62.

Air flow rate can also affect the effectiveness of the air drying system 80. In some applications, roughly proportional drying rate is achieved with a change in dry gas flow rate. For example, reducing the dry gas flow rate by half can double the length of time that it will take to dehydrate the lubricant 62 under certain circumstances. However, it should be noted that these relationships occur within a reasonable range of values and that there is also a minimum and maximum rate within which each particular process will optimally operate. Generally, the minimum air flow rate for air drying systems 80 consistent with the technology disclosed herein will result in an Air Exchange Rate of 2 exchanges/hour, where the Air Exchange Rate quantifies number of times the equivalent volume of gas contained in the airspace 64 is flushed per hour. In another embodiment, the air flow rate of the air drying system 80 results in an Air Exchange Rate of at least 3 airspace exchanges/hour.

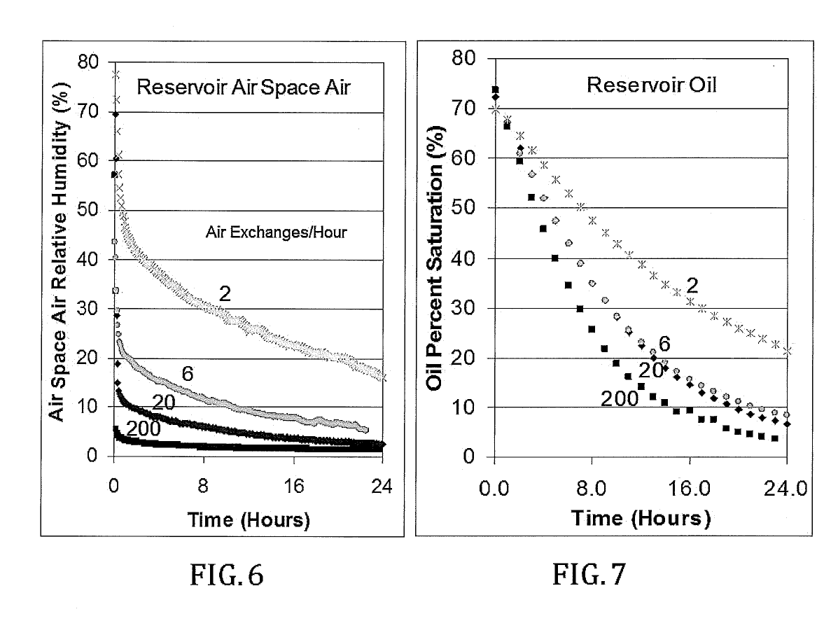

FIGS. 6-7 depict example experimental results of one experimental air drying system for reservoir oil defining an airspace with an initial relative humidity of 80% and an oil temperature of 90 degrees. FIG. 6 depicts the relative humidity of the airspace over time when the air drying system has an Air Exchange Rate of 2 exchanges/hour, 6 exchanges/hour, 20 exchanges/hour and 200 exchanges/hour, respectively. FIG. 7 depicts the percent saturation of the oil is depicted over time when the air drying system has Air Exchange Rates of 2 exchanges/hour, 6 exchanges/hour, 20 exchanges/hour and 200 exchanges/hour. As is demonstrated in FIGS. 6 and 7, increasing the Air Exchange Rate significantly does not necessarily result in correspondingly significant reductions in airspace relative humidity and percent saturation of the oil.

Referring back to FIG. 1, the air drying system 80 consistent with the technology disclosed herein can have other configurations and additional components, as will be appreciated, such as that disclosed in U.S. Pat. Pub. No. 2011/0049015, filed Jun. 30, 2010, which is incorporated herein by reference.

The fluid pump 50 is in fluid communication with the lubricant 62 in the lubricant reservoir 60 and is configured to pump the lubricant 62 through the pump line 40 and lubricant filters 30a, 30b. The filters 30a, 30b are generally configured to prevent the formation of electrostatic potential generated by the lubricant 62 passing through the system 100. In a variety of embodiments, the filter assemblies 30a, 30b incorporate filter media such as the proprietary DERT Media Technology developed by Donaldson Corporation, based in Bloomington, Minn. In at least one embodiment, another type of filter media can be used that is configured to reduce electrostatic charging of the lubricant. Reducing the electrostatic potential of the lubricant generally results in reduction of electrostatic discharge and ionization of particles in oil, thereby reducing wear on system 100 components and other risks. In a variety of embodiments, the filter assemblies 30a, 30b are duplex filters such as a Donaldson Duramax style spin-on filter manifold assembly. Similar manifold assemblies are also contemplated, where such assemblies provide a relative reduction in service time and footprint size when compared to traditional filter pots known in the art.

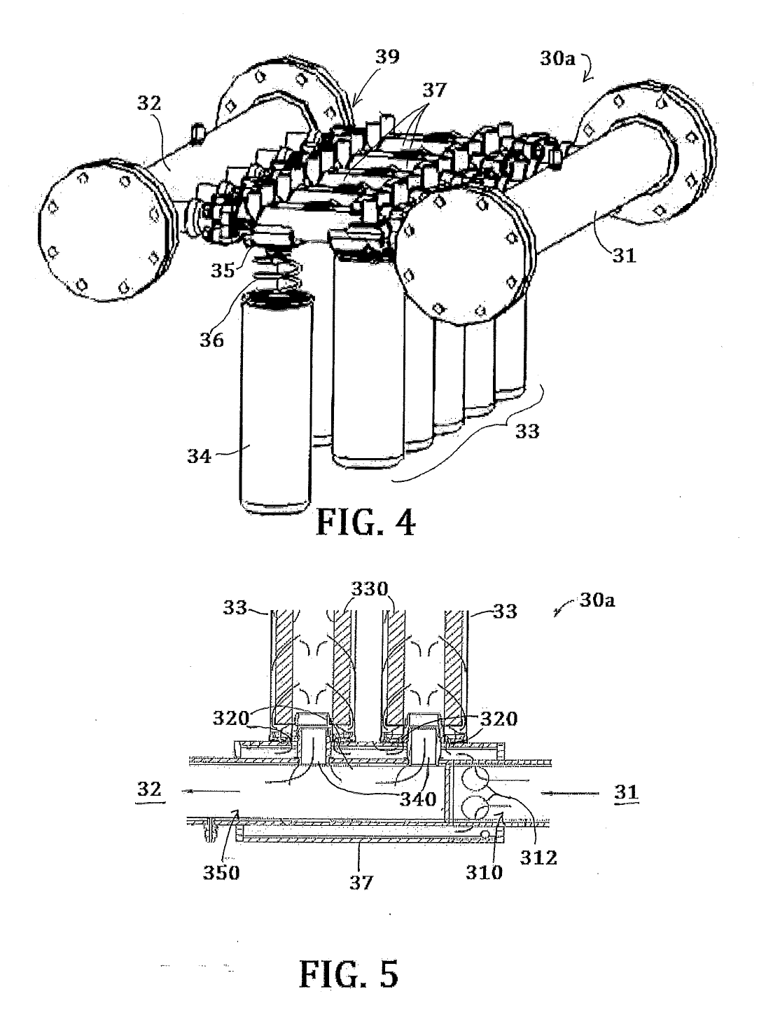

FIG. 4 depicts an example filter manifold assembly 30a consistent with the technology disclosed herein. The filter manifold assembly 30a generally has a manifold arrangement 39 that is operable communication with a plurality of filters 33. The manifold arrangement 39 has an inlet pipe 31 and an outlet pipe 32 that are in fluid communication with the plurality of filters 33. Each filter is coupled to one of a plurality of filter conduits 37 extending from the inlet pipe 31 to the outlet pipe 32. Each of the filter conduits 37 define one or more filter receptacles 35 that are each configured to receive a filter 34. In a variety of embodiments a compression spring 36 is disposed between the filter conduit and each filter 34.

The filters 33, in this example, are depicted as being arranged in parallel flow to each other. By “parallel flow” it is meant that the filters 33 are not arranged in series and the flow of fluid from the inlet pipe 31 to the outlet pipe 32 is through multiple paths, where each of the plurality of filters 33 defines a different path. This type of arrangement allows for relatively faster filtration with a relatively higher flow rate compared to conventional systems, such as up to 500 gallons per minute. Larger versions using a similar design could also be made, which would have higher flow rates. In one particular embodiment, a filter manifold assembly incorporating filters arranged in parallel can be used.

FIG. 5 depicts the fluid flow from the inlet pipe to the outlet pipe through one of the plurality of filters 33. Incoming fluid from the inlet pipe 31 enters the inlet section 310 of the filter conduit 37 which is in fluid communication with two filter inlets 320 through one or more inlet openings 312. The fluid passes through the filter media 330 of the respective filter 33, which can include DERT media in a variety of embodiments, flows through the filter outlet 340, and enters the outlet section 350 of the filter 33. The fluid then exits the filter 33 towards the outlet pipe 32.

In the current embodiment, the outlet section 350 of the filter conduit 37 is embedded within the inlet section 310 of the filter conduit 37, thereby reducing the footprint of the assembly. In a variety of embodiments, the filter manifold assemblies 30a, 30b (See FIG. 1) can be consistent with that disclosed in U.S. patent Ser. No. 13/097,469, which is incorporated by reference herein.

Referring back to FIG. 1, after passing through one of the filter manifold assemblies 30a, 30b, the lubricant 62 is pumped through turbine lines 20 to the turbine bearings 10, where it is used to lubricate the turbine bearings 10. Because of the reduced electrostatic charge of the lubricant, and therefore, reduced electrostatic discharge and damage to filters and oils, wear and varnish on the bearings is prevented.

It should also be noted that, as used in this specification and the appended claims, the phrase “configured” describes a system, apparatus, or other structure that is constructed or configured to perform a particular task or adopt a particular configuration. The phrase “configured” can be used interchangeably with other similar phrases such as “arranged”, “arranged and configured”, “constructed and arranged”, “constructed”, “manufactured and arranged”, and the like.

All publications and patent applications in this specification are indicative of the level of ordinary skill in the art to which this invention pertains. All publications and patent applications are herein incorporated by reference to the same extent as if each individual publication or patent application was specifically and individually indicated by reference.

This application is intended to cover adaptations or variations of the present subject matter. It is to be understood that the above description is intended to be illustrative, and not restrictive.

What is claimed is:

1. A turbine bearing lubricant filtration system comprising:
a lubricant pump configured to be disposed in communication with a lubricant reservoir;
an dry gas source configured to be in fluid communication with the lubricant reservoir;
a breather filter configured to be in communication with the lubricant reservoir; and
a filter manifold assembly having media incorporating electrostatic reduction technology.

2. The system of claim 1, further comprising a dry gas pump between the dry gas source and the reservoir, wherein the dry gas pump is configured to positively pressurize the lubricant reservoir.

3. The system of claim 1, wherein the breather filter is a regenerative hygroscopic filter.

4. The system of claim 3, wherein the breather filter is further configured to filter particulates.

5. The system of claim 1, wherein the dry gas source comprises a dry nitrogen generator.

6. The system of claim 1, wherein the dry gas source comprises a dryer.

7. The system of claim 1, wherein the lubricant pump is configured to pump lubricant to one or more turbine bearings.

8. The system of claim 1, wherein the breather filter defines a diffusion aperture having a labyrinth arrangement.

9. The system of claim 1, wherein the breather filter comprises a first adsorbent material and a second adsorbent material, wherein the first adsorbent material has a higher capacity of adsorption at a high relative humidity and the second adsorbent material has a higher capacity of adsorption at a lower relative humidity.

10. The system of claim 1, wherein the dry gas source is configured to provide gas at an Air Exchange Rate of at least 2 airspace exchanges per hour.
